(19) United States
(12) Patent Application Publication
(10) Pub. No.: US 2024/0209690 A1
(43) Pub. Date: Jun. 27, 2024

(54) THERMAL RUNAWAY MITIGATION IN ELECTRIC MINING MACHINES

(71) Applicant: Joy Global Underground Mining LLC, Warrendale, PA (US)

(72) Inventor: Nehul Bhambri, Sudbury (CA)

(21) Appl. No.: 18/544,261

(22) Filed: Dec. 18, 2023

Related U.S. Application Data
(60) Provisional application No. 63/434,364, filed on Dec. 21, 2022.

(51) Int. Cl. E21B 7/02; H01M 10/613

(52) U.S. Cl. CPC E21B 7/025; H01M 10/613; H01M 2220/20

(57) ABSTRACT

A thermal management system comprising an enclosure housing a battery pack, wherein the enclosure includes an inlet, a sensor configured to sense a characteristic associated with the battery pack, and a controller coupled to the sensor. The controller is configured to receive a signal indicative of the characteristic associated with the battery pack from the sensor, determine, based on the characteristic associated with the battery pack, that a condition indicative of a thermal runaway event is satisfied, and in response, cause water to flow into the enclosure through the inlet.

### CROSS-REFERENCE TO RELATED APPLICATION

This application claims the benefit of co-pending U.S. Provisional Patent Application No. 63/434,364, filed Dec. 21, 2022, the entire contents of which are incorporated by reference.

### FIELD

The present disclosure relates to mining machines, and more specifically, to thermal runaway mitigation in electric mining machines.

### BACKGROUND

An electric vehicle, such as an electric mining machine, may rely on one or more battery packs, which respectively comprises one or more interconnected battery cells, to power various components and/or systems of the electric vehicle. During operation of an electric vehicle, the one or more battery packs are discharged to output power. The one or more battery packs can be recharged when the electric vehicle is not in use and/or during operation of the electric vehicle.

### SUMMARY

In one independent aspect, a thermal management system comprises an enclosure housing a battery pack, wherein the enclosure includes an inlet, a first sensor configured to sense a first characteristic associated with the battery pack, and a controller coupled to the first sensor. The controller is configured to receive a first signal indicative of the first characteristic associated with the battery pack from the first sensor, determine, based on the first characteristic associated with the battery pack, that a condition indicative of a thermal runaway event is satisfied, and in response, cause water to flow into the enclosure through the inlet.

In some aspects, the characteristic associated with the battery pack includes at least one of an amount of a gas within the enclosure, a concentration of a gas within the enclosure, an ambient temperature within the enclosure, a temperature of the battery pack, a voltage of the battery pack, or a current output by the battery pack.

In some aspects, the controller is further configured to disconnect the battery pack from a component of the thermal management system in response to determining that the condition indicative of the thermal runaway event is satisfied.

In some aspects, the sensor is a first sensor, the characteristic is a first characteristic associated with the battery pack, the signal is a first signal, and the system further includes a second sensor configured to sense a water level within the enclosure.

In some aspects, the controller is further configured to receive a second signal indicative of a water level within the enclosure from the second sensor; determine, based on the second signal, that the water level within the enclosure exceeds a target water level; and in response, cause water to stop flowing into the enclosure.

In some aspects, the controller is further configured to receive a third signal indicative of an updated water level with the enclosure from the second sensor; determine, based on the third signal, that the updated water level within the enclosure is less than the target water level; and in response, cause water to flow into the enclosure through the inlet.

In some aspects, the controller is further configured to transmit a message that indicates the occurrence of a thermal runaway event to an external device in response to determining that the condition indicative of the thermal runaway event is satisfied.

In some aspects, the system further includes a second sensor configured to sense a second characteristic associated with the battery pack; and the controller is further configured to receive a second signal indicative of the second characteristic associated with the battery pack from the second sensor.

In some aspects, the characteristic associated with the battery pack is a concentration of a gas within the enclosure and the second characteristic associated with the battery pack is an ambient temperature within the enclosure.

In some aspects, to determine that the condition indicative of the thermal runaway event is satisfied, the controller is further configured to determine, based on the signal, that the concentration of the gas within the enclosure exceeds a first threshold or determine, based on the second signal, that the temperature within the enclosure exceeds a second threshold.

In another independent aspect, a method for mitigating thermal runaway includes receiving, from sensor, a signal indicative of a characteristic associated with a battery pack; determining, based on the characteristic associated with the battery pack, that a condition indicative of a thermal runaway event is satisfied; and in response, causing water to flow into an enclosure that houses the battery pack.

In some aspects, the method further includes transmitting a message indicative of the occurrence of a thermal runaway event to an external device in response to determining that the condition indicative of the thermal runaway event is satisfied.

In some aspects, the method further includes receiving, from a second sensor, a second signal indicative of a water level within the enclosure; determining, based on the second signal, that the water level within the enclosure exceeds a target water level; and in response, causing water to stop flowing into the enclosure.

In some aspects, the method further includes receiving, from the second sensor, a third signal indicative of an updated water level within the enclosure; determining, based on the third signal, that the updated water level within the enclosure is less than the target water level; and in response, causing water to flow into the enclosure.

In some aspects, determining that the condition indicative of the thermal runaway event is satisfied includes determining, based on the signal, that an amount of gas within the enclosure exceeds a threshold.

In some aspects, determining that the condition indicative of the thermal runaway event is satisfied includes determining, based on the signal, that a temperature within the enclosure exceeds a threshold.

In another independent aspect, a plurality of traction devices supporting the electric vehicle for movement; an enclosure housing a battery pack that provides power to one or more components included in the electric vehicle; a first sensor configured to sense a first characteristic associated with the battery pack; a second sensor configured to sense a second characteristic associated with the battery pack; and a controller coupled to the first sensor. The controller is configured to receive a first signal indicative of the first characteristic associated with the battery pack from the first sensor; receive a second signal indicative of the second characteristic associated with the battery pack from the second sensor; determine, based on at least one of the first characteristic associated with the battery pack or the second characteristic associated with the battery pack, that a condition indicative of a thermal runaway event is satisfied; and in response, transmit a message that indicates the occurrence of a thermal runaway event to an external device.

In some aspects, the controller is further configured to cause water to flow into the enclosure in response to determining that the condition indicative of the thermal runaway event is satisfied.

In some aspects, the first characteristic associated with the battery pack is a voltage associated with the battery pack and the second characteristic associated with the battery pack is a current associated with the battery pack.

In some aspects, the electric vehicle is a mining machine including an attachment for drilling holes in a mine surface.

Other aspects will become apparent by consideration of the detailed description and accompanying drawings.

### BRIEF DESCRIPTION OF THE DRAWINGS

FIG. 1A illustrates a side view of an electric mining machine, according to aspects of the various embodiments.

FIG. 1B illustrates a plan view of the electric mining machine of FIG. 1A, according to various embodiments.

FIG. 2 is a block diagram of an energy storage system for the electric mining machine of FIG. 1A, according to various embodiments.

FIG. 3 is a block diagram of a control system for the electric mining machine of FIG. 1A, according to various embodiments.

FIG. 4 is a block diagram of a thermal management system for the electric mining machine of FIG. 1A, according to various embodiments.

FIG. 5 is a flow diagram of method steps for mitigating thermal runaway in an electric vehicle, according to various embodiments.

FIG. 6 is a flow diagram of method steps for mitigating thermal runaway in an electric vehicle, according to other various embodiments.

### DETAILED DESCRIPTION

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more electronic processors, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more electronic processors, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4.” The relative terminology may refer to plus or minus a percentage (e.g., 1%, 5%, 10%, or more) of an indicated value.

Functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not explicitly listed.

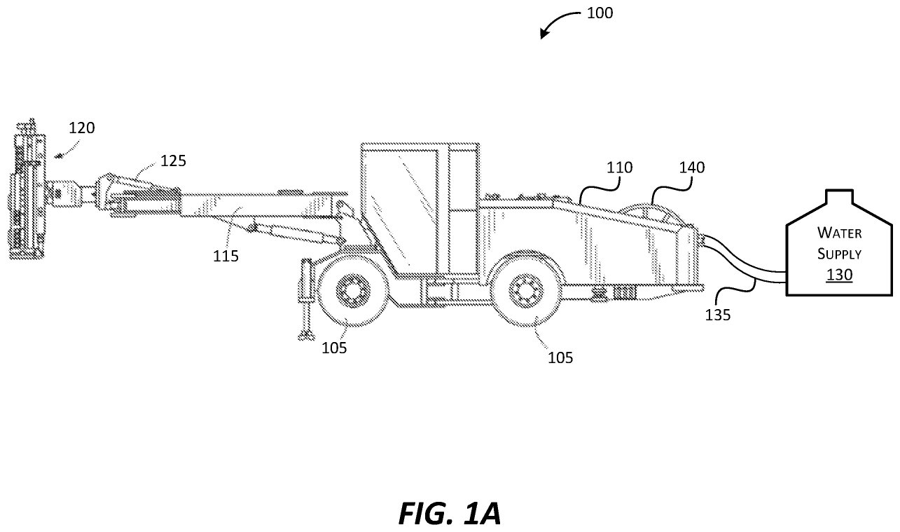

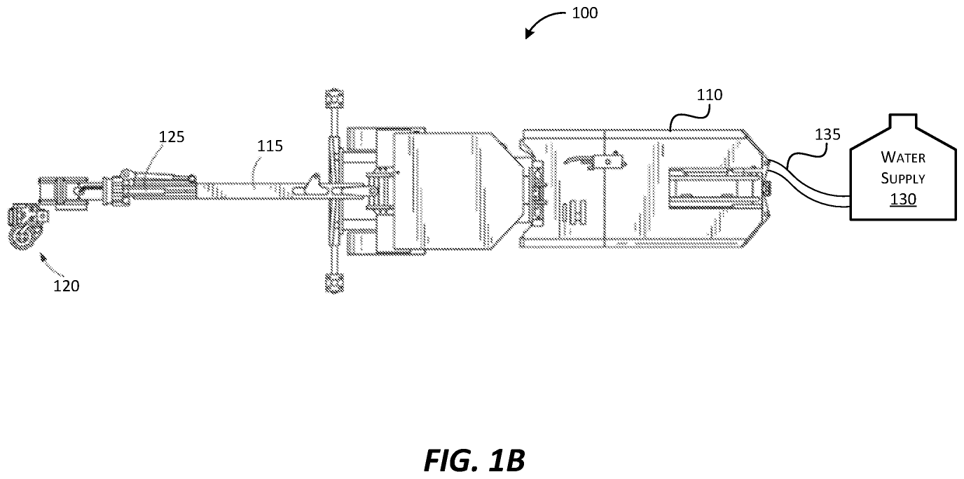

FIG. 1A illustrates a side view of an electric mining machine 100, according to aspects of the various embodiments. FIG. 1B illustrates a plan view of the electric mining machine of FIG. 1A, according to various embodiments. In the illustrated example of FIGS. 1A and 1B, the electric mining machine 100 is a bolter. However, persons skilled in the art will understand that a bolter is just one non-limiting example of an electric mining machine that could be implemented as the electric mining machine 100 and that, in other examples, a different type of electric mining machine could be implemented as the electric mining machine 100. For example, the electric mining machine 100 can be implemented as a hard rock drill, a load haul dump (LHD) machine, or some other type of electric mining machine. Furthermore, although the disclosed systems and methods for thermal runaway mitigation are described herein with respect to the electric mining machine 100, in some examples, the disclosed systems and methods can more generally be used for mitigating thermal runaway in electric vehicles that are not mining machines. Accordingly, in some examples, electric mining machine 100 is implemented as an electric vehicle that is not a mining machine.

As shown in FIG. 1A, the electric mining machine 100 includes a traction mechanism 105 (e.g., wheels), an energy storage system 110, and a boom 115. In the illustrated example of FIGS. 1A and 1B, the energy storage system 110 is supported adjacent a rear end of the electric mining machine 100. However, in some examples, the energy storage system 110 is supported by and/or disposed at a different portion of the electric mining machine 100 (e.g., the middle of the electric mining machine 100 or the front end of the electric mining machine 100). As will be described in more detail herein, the energy storage system 110 includes one or more battery packs that provide operational power to various systems and components of the electric mining machine 100.

The boom 115 supports a drilling and bolting rig, or drill device 120, for forming holes in a mine surface (e.g., a roof, a floor, or a rib or side wall—not shown) and/or installing a drill element (e.g., a bit or a bolt). In the illustrated example of FIGS. 1A and 1B, the drill device 120 performs both drilling and bolting operations. The drill device 120 can be moved relative to the boom 115 by a linear actuator 125. For example, the linear actuator 125 positions and/or indexes the drill device 120 from one bolting position to another.

As further shown in FIG. 1A, the electric mining machine 100 can be removably coupled to a water supply 130 via a hose or similar water conduit 135. In the illustrated example of FIG. 1A, the hose 135 is supported on a reel system 140 such that the hose 135 can be unwound from the reel system 140 to connect the electric mining machine 100 to the water supply 130 and wound up around the reel system 140 when not in use. In the illustrated example of FIGS. 1A and 1B, the water supply 130 is external to the electric mining machine 100. Some non-limiting examples of external water supplies that can be used to implement the water supply 130 include a water tank, a water reservoir, or a water supply line. In some examples not shown, the water supply 130 is an internal water supply, such as a tank, that is supported by and/or disposed within the electric mining machine 100. In some examples, the electric mining machine 100 includes an internal water supply and can also be removably coupled to an external water supply 130. As will be described in more detail herein, water from the water supply 130 can be used to cool the energy storage system 110 during a thermal runaway event.

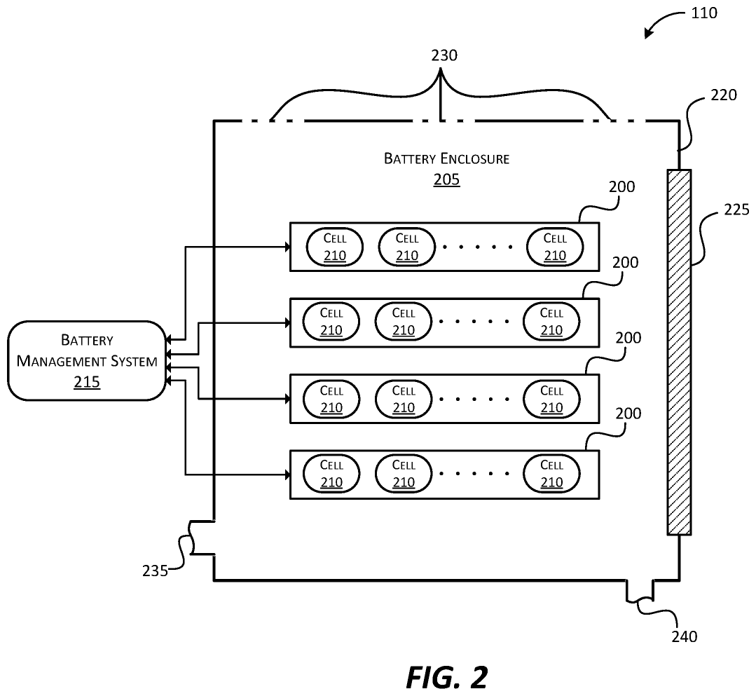

FIG. 2 is a block diagram of the energy storage system 110 for the electric mining machine 100 of FIGS. 1A and 1B, according to various embodiments. As shown, the energy storage system 110 includes a plurality of battery packs 200 that are housed, or disposed, within a battery enclosure 205. In the illustrated example of FIG. 2, the energy storage system 110 includes four battery packs 200. However, persons skilled in the art will understand that, in other examples, the energy storage system 110 can include fewer or more than four battery packs 200. For example, the energy storage system 110 can include one battery pack, two battery packs, eight battery packs, twelve battery packs, or some other number of battery packs. In some non-limiting examples, capacity of the energy storage system 110 may be between approximately 70 kWh and approximately 200 kWh. In other non-limiting examples, the capacity of the energy storage system 110 can be greater than 200 kWh.

Each battery pack 200 in the energy storage system 110 comprises a housing that surrounds, or encloses, a plurality of battery cells 210 that are connected in series and/or parallel with each other. In this regard, the output voltage of a respective battery pack 200 is equal to the combined voltage of the interconnected battery cells 210 included in the respective battery pack 200. In some non-limiting examples, the output voltage of a respective battery pack 200 may be between approximately 220V and approximately 880V. In one particular non-limiting example, the output voltage of a respective battery pack 200 is 660V. In the illustrated example of FIG. 2, each battery pack 200 is shown to include a plurality of battery cells 210. Persons skilled in the art will understand that the number of battery cells 210 shown in FIG. 2 is a non-limiting example, and that in other examples, a battery pack 200 can include fewer or more than the illustrated number of battery cells 210. In some examples, the battery cells 210 have a lithium-ion chemistry. One non-limiting example of a lithium-ion chemistry is lithium-iron phosphate. In other examples, the battery cells 210 may have a different chemistry such as a nickel-metal hydride chemistry, a lead-acid chemistry, a nickel-cadmium chemistry, or another chemistry.

Similar to the battery cells 210, the battery packs 200 can selectively be connected in series and/or parallel with each other. For example, a battery pack 200 can selectively be connected to one or more other battery packs 200 via one or more switches. In this regard, the output voltage of the energy storage system 110 can be equal to a combined voltage output by one or more of the interconnected battery packs 200. In some examples, the energy storage system 110 outputs voltage at a first voltage level to some components of the electric mining machine 100, such as motors or hydraulic components, and outputs voltage at one or more other voltage levels to one or more other components (e.g., pumps, fans, lights, etc.) of the electric mining machine 100.

Referring back to FIG. 2, the energy storage system 110 further includes a battery management system (BMS) 215 and charging circuitry (not shown) that is connected to each of the battery packs 200. In operation, the BMS 215 monitors various characteristics of the battery packs 200. For example, the BMS 215 includes and/or is coupled to voltage sensors that sense the voltage levels of the battery packs 200 and/or the voltage levels of the individual battery cells 210 included in the battery packs 200. In some examples, the BMS 215 further includes and/or is coupled to temperature sensors that sense temperatures of the battery packs 200 and/or temperatures of the battery cells 210 included in the battery packs 210. In some examples, the BMS 215 includes and/or is coupled to current sensors that sense the current output of one or more battery packs 200, one or more battery cells 210, and/or the energy storage system 110.

The BMS 215 can also control functions such as charging the battery packs 200 and connecting and/or disconnecting battery packs 200 from each other via switches. As will be described in more detail herein, the BMS 215 can be coupled to a central controller, such as a vehicle control unit, of the electric mining machine 100 to share information associated with the battery packs 200. In some examples, one or more of the functions described herein as being performed by the BMS 215 can alternatively be performed by the central controller of the mining machine 100. The charging circuitry included in the energy storage system 110 includes one or more voltage converters for converting input power to a voltage level used for charging the battery packs 200. In the illustrated example of FIG. 2, the BMS 215 is external to the battery enclosure 205. However, in some examples, the BMS 215 is disposed partially or wholly within the battery enclosure 205.

The battery packs 200 are housed within the battery enclosure 205, which protects the battery packs 200 from the environment surrounding the electric mining machine 100. As shown in FIG. 2, the battery enclosure 205 includes an external housing 220 that defines an interior in which the battery packs 200 are disposed. The external housing 220 of the battery enclosure can be constructed from, for example, one or more materials such as steel, aluminum, fiberglass, plastic, or some other durable material. In some examples, the battery enclosure 205 is an IP67-rated enclosure that is configured to protect the battery packs 200 from dust, water, and other environmental conditions. In the illustrated example of FIG. 2, the external housing 220 of the battery enclosure 205 further includes and/or is coupled to a gasketed bulkhead plate 225. The gasketed bulkhead plate 225 can be used to mount the battery packs 200 within the battery enclosure 205 and includes one or more airtight connection points that allow for the battery packs 200 to be electrically connected to other components of the electric mining machine 100.

As further shown in FIG. 2, the battery enclosure 205 includes a plurality of vents 230 that are disposed on and/or attached to the external housing 220. In some embodiments, the vents 230 may be disposed at or near an upper portion of the external housing 220 to allow for gases and steam to exit the battery enclosure 205 from the external housing 220 while keeping any liquids and solids inside of the battery enclosure 205. In some examples, the vents 230 vents are implemented as that restrict or prevent liquid egress while allowing gas egress. One non-limiting example of a vent that restricts or prevents liquid egress while allowing gas egress is a GORE vent. In the illustrated example of FIG. 2, three vents 230 are disposed on the upper portion of the external housing 220. However, persons skilled in the art will understand that the number and position of the vents 230 shown in FIG. 2 is non-limiting, and that in other examples, fewer or more than three vents 230 could be disposed in the battery enclosure 205. Also, vents may be positioned in another portion of the external housing 220.

The battery enclosure 205 further includes a water inlet 235 and a drain 240 that are disposed at or near a lower portion (e.g., a bottom surface) of the external housing 220. As will be described in more detail herein, water and/or other liquids can be pumped or otherwise introduced into the interior of the battery enclosure 205 via the water inlet 235. For example, one or more pumps and or valves can be used to cause water to flow from a water supply into the battery enclosure 205. Similarly, the drain 240 can be used to drain and/or remove any built-up condensation, water, and/or other liquids from the battery enclosure 205. For example, one or more pumps and/or valves can be used to remove water from the battery enclosure 205 via the drain 240. Although only one water inlet 235 and one drain 240 are shown in the illustrated example of FIG. 2, persons skilled in the are will understand that, in other examples, the battery enclosure 205 can include more than one water inlet 235 and/or more than one drain 240.

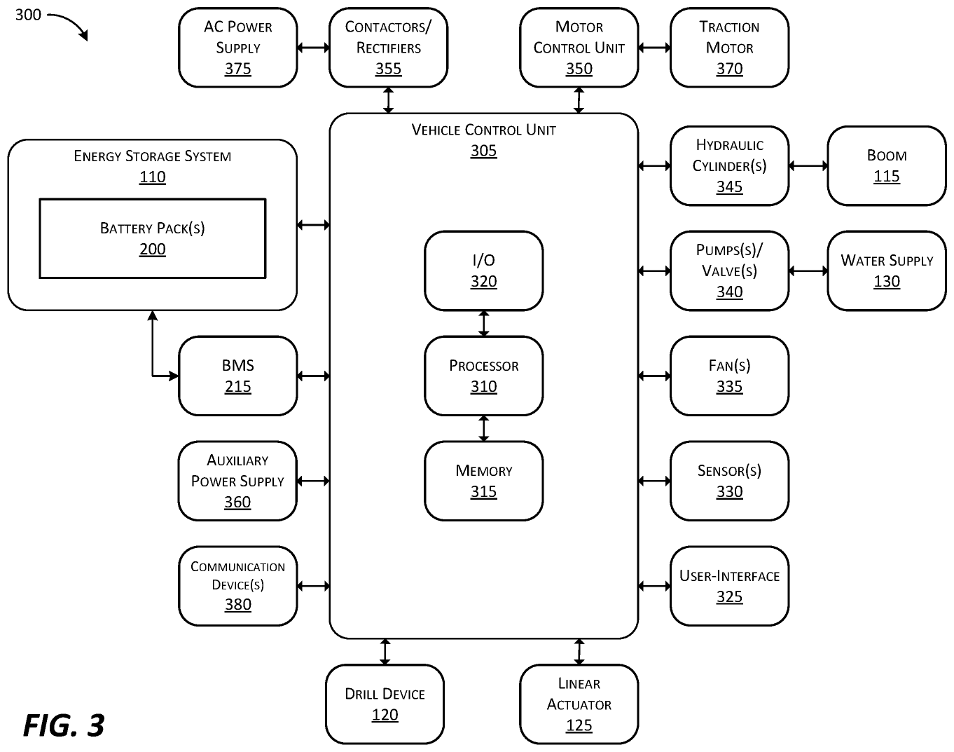

FIG. 3 is a block diagram of a control system 300 for the electric mining machine 100 of FIGS. 1A and 1B, according to various embodiments. As shown, the control system 300 includes a central controller, or vehicle control unit (VCU), 305 that controls operation of various components and/or systems of the electric mining machine 100. The VCU 305 includes a processor 310 (e.g., a microprocessor, a microcontroller, or another suitable programmable device), a memory 315, and an input/output (“I/O”) system 320 that are interconnected by a bus.

The I/O system 320 includes routines for transferring information between components within the VCU 305 and other components of the electric mining machine 100. In some examples, the I/O system 320 further includes a communication interface that is configured to provide communication between the electric mining machine 100 and one or more external communication devices 380 (e.g., a smart phone, a tablet, a laptop, etc.). In some examples, the communication interface includes the I/O system 320 and enables the VCU 305 to communicate with communication devices 380 associated with operators of the electric mining machine 100 and/or workers in proximity of the electric mining machine 100. In such examples, the VCU 305 communicates with the one or more communication devices 380 through a network. The network is, for example, a wide area network (WAN) (e.g., the Internet, a TCP/IP based network, a cellular network, such as, for example, a Global System for Mobile Communications [GSM] network, a General Packet Radio Services [GPRS] network, a Code Division Multiple Access [CDMA] network, an Evolution-Data Optimized [EV-DO] network, an Enhanced Data Rates for GSM Evolution [EDGE] network, a 3 GSM network, a 4GSM network, a Digital Enhanced Cordless Telecommunications [DECT] network, a Digital AMPS [IS-136/TDMA] network, or an Integrated Digital Enhanced Network [iDEN] network, etc.). In other examples, the network is, for example, a local area network (LAN), a neighborhood area network (NAN), a home area network (HAN), or personal area network (PAN) employing any of a variety of communications protocols, such as Wi-Fi, Bluetooth, ZigBee, etc. In some examples, the network includes one or more of a wide area network (WAN), a local area network (LAN), a neighborhood area network (NAN), a home area network (HAN), or personal area network (PAN).

The memory 315 includes, for example, a read-only memory (“ROM”), a random access memory (“RAM”), an electrically erasable programmable read-only memory (“EEPROM”), a flash memory, a hard disk, an SD card, or another suitable magnetic, optical, physical, or electronic memory device. The memory 315 stores software, such as but not limited to firmware, one or more applications, program data, one or more program modules, and/or other executable instructions, for controlling operation of one or more components and systems of the electric mining machine 100. In operation, the processor 310 retrieves from the memory 315 and executes software instructions for controlling operation of one or more components and systems of the electric mining machine 100. For example, in operation, the processor 310 retrieves from memory 315 and executes, among other things, software instructions associated with the processes and methods described herein for detecting and mitigating thermal runaway.

Hereinafter, functions and/or actions performed by components of the VCU 305 (e.g., processor 310, memory 315, and I/O system 320) can collectively be referred to as being performed by the VCU 305.

Referring back to FIG. 3, the control system 300 for the electric mining machine 100 includes various components and/or systems that are coupled to and controlled by the VCU 305. For example, the VCU 305 is coupled to the energy storage system 110 and the BMS 215. As described above, the BMS 215 includes and/or is coupled to various sensors that sense voltages, temperatures, current output, and/or other characteristics of the battery packs 200 and/or individual battery cells 210 included in the energy storage system 110. In operation, the BMS 215 can transmit signals to the VCU 305 that includes information indicative of characteristics (e.g., voltages, temperatures, and/or current outputs) associated with the battery packs 200 and/or battery cells 210 and, based on the characteristics associated with the battery packs 200 and/or battery cells 210, the VCU 305 can control charging and/or discharging of the battery packs 200, control power delivery from the energy storage system 110 to one or more components of the electric mining machine 100, and/or control operation of one or more other components included in the electric mining machine 100. In some examples, the VCU 305 is directly coupled to one or more of the sensors that sense characteristics associated with battery packs 200 and/or battery cells 210 included in the energy storage system 110. In such examples, the VCU 305 can receive signals that includes information indicative of characteristics (e.g., voltages, temperatures, and/or current outputs) associated with the battery packs 200 and/or battery cells 210 directly from the sensors that sense characteristics associated with the battery packs 200 and/or battery cells 210.

As further shown in FIG. 3, the VCU 305 is coupled to the drill device 120, the linear actuator 125, a user-interface 325, one or more sensors 330, one or more fans 335, one or more pumps and/or valves 340, one or more hydraulic cylinders 345, a motor control unit (MCU) 350, one or more contactors and rectifiers 355, and an auxiliary power supply 360. The VCU 305 can control operation of the drill device 120. The VCU 305 can also control operation of the linear actuator 125 for causing movement of the drill device 120.

The user-interface 325 is configured to receive input from an operator of the electric mining machine 100 and/or output information to the operator of the electric mining machine 100. In some examples, the user-interface 325 includes a display (e.g., a primary display, a secondary display, etc.) and/or input devices (e.g., touchscreen displays, a plurality of knobs, dials, switches, buttons, levers, joysticks, etc.). The display may be, for example, a liquid crystal display (“LCD”), a light-emitting diode (“LED”) display, an organic LED (“OLED”) display, an electroluminescent display (“ELD”), a surface-conduction electron-emitter display (“SED”), a field emission display (“FED”), a thin-film transistor (“TFT”) LCD, etc. In some examples, the user-interface 325 includes one or more audio indicators (e.g., speakers, horns, buzzers, etc.) and/or visual indicators such as LEDs.

The one or more sensors 330 are configured to sense various characteristics associated with components and/or systems of the electric mining machine 100. For examples, the one or more sensors 330 can include, without limitations, voltage sensors that sense various voltages within the electric mining machine 100, current sensors that sense various currents flowing through the electric mining machine 100, temperature sensors that sense various temperatures within the electric mining machine 100, gas sensors, water level sensors, rotational sensors, positional sensors, torque sensors, pressure sensors, and/or other types of sensors that sense characteristics associated with components and systems of the electric mining machine 100. In operation, the VCU 305 controls operation of one or more components of the electric mining machine 100 based on signals received from the one or more sensors 330.

The VCU 305 can control operation of the one or more fans 335 to force cooling air over components of the electric mining machine 100, such as the energy storage system 110. In addition, the VCU 305 can control operation of one or more pumps and/or valves 340 to control the flow of cooling water into and out of the battery enclosure 205. For example, the VCU 305 can selectively activate a pump 340 and/or open a valve 340 to cause cooling water to flow from the water supply 365 into the battery enclosure 205. As another example, the VCU 305 can activate a pump 340 and/or open a valve 340 to remove water from the battery enclosure 205 via the drain 240.

Furthermore, in operation, the VCU 305 can control operation of one or more hydraulic cylinders 345 to move the boom 115 and/or communicate with the MCU 350 to control the wheel motors 370 that drive the traction mechanism 105 (e.g., wheels) of the electric mining machine 100. In such examples, the VCU 305 can control the flow of power from the energy storage system 110 to the hydraulic cylinders 345 for causing movement of the boom 115 and/or to the traction motors 370 for driving the traction mechanism 105 (e.g., wheels) of the electric mining machine 100.

As further shown in FIG. 3, the VCU 305 is coupled to an auxiliary power supply 360 and, via one or more contactors and rectifiers 355, an AC power supply 375. In some examples, the auxiliary power supply 360 is a low voltage (e.g., 24V, 12V, etc.) DC power supply that provides operational power to the VCU 305 and/or other low voltage components of the electric mining machine 100. For example, the auxiliary power supply 360 can include one or more battery packs that are used to power the VCU 305 during a thermal runaway event.

The AC power supply 375 is external to the electric mining machine 100 and provides high voltage (e.g., 220V, 480V, 1,000V, etc.) AC power that is used to charge the battery packs 200 and/or power high voltage components (e.g., traction motors 370 or hydraulic cylinders 345) of the electric mining machine 100. As shown, the VCU 305 is coupled to and can control one or more contactors and/or rectifiers 355 to control the flow of AC power from the AC power supply 375. For example, the VCU 305 can disconnect the electric mining machine 100 from the AC power supply 375 by disconnecting the contactors 355 from the AC power supply 375. As another example, the VCU 305 can control the rectifiers 355 to convert high voltage AC power provided by the AC power supply 375 into DC power for charging the battery packs 200 included in the energy storage system 110. In some examples, the AC power supply 375 is the grid. In other examples, the AC power supply 375 is a generator.

During operation of an electric vehicle, the battery packs and/or one or more individual battery cells included in the battery packs that power the electric vehicle can experience thermal runaway. For example, the battery packs 200 included in the energy storage system 110 and/or one or more battery cells 210 included in the battery packs 200 can experience thermal runaway during operation of the electric mining machine 100. A battery pack and/or one or more battery cells included in a battery pack can enter thermal runaway as a result of rapid charging/discharging of the battery pack, short circuits, overcharging the battery cells beyond a maximum voltage level, manufacturing defects, and/or other conditions that cause the temperature of battery cells to increase. During a thermal runaway event, chemical reactions within a battery cell cause the battery cell to heat up and release gases at higher rates and/or in higher concentrations than during normal operation of the battery cell. If a thermal runaway event goes undetected and/or untreated, the battery packs and/or individual battery cells experiencing thermal runaway can catch fire and/or explode, thereby causing significant damage to the electric vehicle and posing serious safety risks to people nearby.

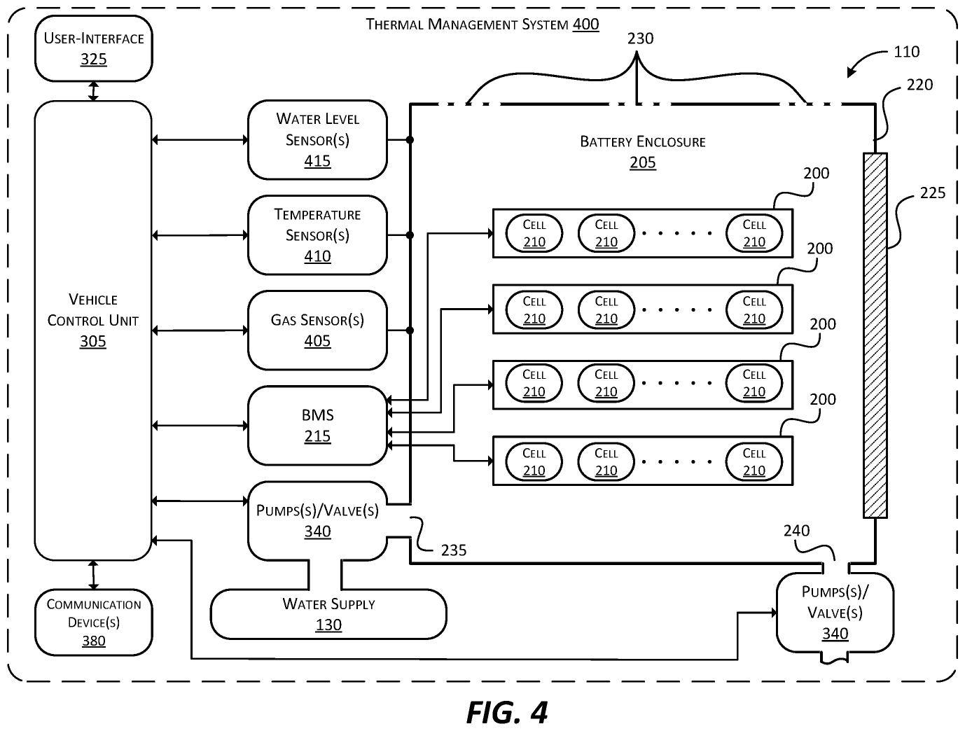

FIG. 4 is a block diagram of a thermal management system for the electric mining machine 100 of FIGS. 1A and 1B, according to various embodiments. As will be described in more details herein, the thermal management system 400 can detect and mitigate the occurrence of a thermal runaway event caused by the battery packs 200 included in the energy storage system 110 of the electric mining machine and/or one or more individual battery cells 210 included in the battery packs 200 included in the energy storage system 110 of the electric mining machine 100. Hereinafter, thermal runaway events caused by the battery packs 200 and/or one or more individual battery cells 210 included in the battery packs 200 included in the energy storage system 110 of the electric mining machine 100 can simply be referred to as a thermal runaway event associated with one or more battery packs 200.

As shown in FIG. 4, the thermal management system 400 includes and/or is coupled to various components described herein with respect to FIGS. 1A-3. For example, the thermal management system 400 includes the BMS 215, the VCU 305, one or more pumps and valves 340, one or more gas sensors 405, one or more temperature sensors 410, and one or more water level sensors 415. In some examples, the thermal management system 400 further includes and/or is coupled to the user-interface 325 and/or one or more communication devices 380. In operation, the VCU 305 detects the occurrence of a thermal runaway event associated with one or more battery packs 200 based on signals received from the BMS 215, the one or more gas sensors 405, and the one or more temperature sensors 410. For example, as will be described in more detail herein, the VCU 305 determines whether a condition indicative of the occurrence of a thermal runaway event associated with one or more battery packs 200 is satisfied based on characteristics associated with the one or more battery packs 200 that are sensed by and included in the signals received from the BMS 215, the one or more gas sensors 405, and the one or more temperature sensors 410.

As described above, the BMS 215 includes and/or is coupled to various sensors that sense voltages, temperatures, current output, and/or other characteristics associated with the battery packs 200 and/or individual battery cells 210 included in the energy storage system 110. In operation, the BMS 215 can transmit signals to the VCU 305 that includes information indicative of characteristics (e.g., voltages, temperatures, and/or current outputs) associated with the battery packs 200 and/or battery cells 210. Based on the information indicative of the characteristics associated with the battery packs 200 and/or battery cells 210 included in the signals received from the BMS 215, the VCU 305 can determine whether a condition indicative of the occurrence of a thermal runaway event associated with a battery pack 200 is satisfied. In some examples, the VCU 305 determines that a condition indicative of the occurrence of a thermal runaway event associated with a battery pack 200 is satisfied when the temperature of a battery packs 200 and/or battery cells 210 exceeds a temperature threshold (e.g., 120 degrees Celsius as a non-limiting example) associated with thermal runaway of a battery pack 200, when the voltage of a battery pack 200 traverses a voltage threshold (e.g., the maximum voltage of the battery pack 200) associated with thermal runaway of a battery pack 200, and/or when an individual battery cell 210 traverses a voltage threshold (e.g., 4.5V as a non-limiting example) associated with thermal runaway of a battery pack 200. In some examples, the VCU 305 determines that a condition indicative of the occurrence of a thermal runaway event associated with a battery pack 200 is satisfied when the current output of a battery pack 200 and/or battery cells 210 exceeds a current threshold associated with thermal runaway of a battery pack 200.

Prior to and/or during thermal runaway of a battery pack 200, the battery cells 210 in the battery pack 200 heat up and release gases, such as but not limited to, hydrogen, carbon monoxide, carbon dioxide, and/or various hydrocarbons. Accordingly, one or more gas sensors 405 that are configured to sense amounts and/or concentrations of a gases associated with thermal runaway of a battery pack 200 are disposed proximate to and/or within the battery enclosure 205. In operation, a gas sensor 405 senses an amount and/or concentration of a gas (e.g., hydrogen, carbon monoxide, carbon dioxide, and/or one or more various other hydrocarbons) within the battery enclosure 205 and transmits signals indicative of the amount and/or concentration of the gas within the battery enclosure 205 to the VCU 305. The VCU 305 then determines whether a condition indicative of a thermal runaway event associated with a battery pack 200 is satisfied based on the amount and/or concentration of the gas within the battery enclosure 205. For example, the VCU 305 determines that a condition indicative of a thermal runaway event associated with a battery pack 200 is satisfied when the amount and/or concentration of the gas within the battery enclosure 205 exceeds a gas threshold associated with thermal runaway of a battery pack 200. The gas threshold can be dependent on the chemistry of the battery cells 210 and/or the size of the battery pack 200.

In some examples, the thermal management system 400 includes a respective gas sensor 405 for each type of gas that is released during thermal runaway of a battery pack 200. For example, if a battery pack 200 releases a first gas (e.g., hydrogen) and a second gas (e.g., carbon monoxide) during thermal runaway, the thermal management system 400 can include a first gas sensor 405 that senses an amount and/or concentration of the first gas within the battery enclosure 205 and a second gas sensor 405 that senses an amount and/or concentration of the second gas within the battery enclosure 205. In some examples, a single gas sensor 405 included in the thermal management system 400 can be configured to sense the amount and/or concentration of a single gas within the battery enclosure 205 or be configured to sense the respective amounts and/or concentrations of multiple gases within the battery enclosure 205.

Prior to and/or during thermal runaway of a battery pack 200, the battery cells 210 in the battery pack 200 generate and dissipate heat. Accordingly, one or more temperature sensors 410 that are configured to sense the ambient temperature within the battery enclosure 205 and/or the temperature of the external housing 220 of the battery enclosure 205 are disposed on, proximate to, and/or within the battery enclosure 205. Although the BMS 215 includes and/or is coupled to temperature sensors that sense the respective temperatures of the battery packs 200 and/or battery cells 210, in some examples, the one or more temperature sensors 410 can also be configured to sense the respective temperatures of the battery packs 200 and/or the battery cells 210. In operation, a temperature sensor 410 senses a temperature associated with a battery pack 210 (e.g., an ambient temperature within the battery enclosure 205, a temperature of the external housing 220 of the battery enclosure 205, a temperature of a battery pack 200, and/or a temperature of a battery cell 210) and transmits signals indicative of the temperature associated with the battery pack 200 to the VCU 305. The VCU 305 then determines whether a condition indicative of a thermal runaway event associated with the battery pack 200 is satisfied based on the sensed temperature associated with the battery pack 200. For example, the VCU 305 determines that a condition indicative of a thermal runaway event associated with the battery pack 200 is satisfied when the temperature associated with the battery pack 200 exceeds a temperature threshold (e.g., 150 degrees Celsius as a non-limiting example) associated with thermal runaway of a battery pack 200.

As described herein, the VCU 305 can determine whether various conditions indicative of the occurrence of a thermal runaway event associated with a battery pack 200 are satisfied based on characteristics associated with the battery pack 200 that are sensed and/or received from the BMS 215, the gas sensors 405, and/or the temperature sensors 410. In some examples, the VCU 305 determines that a condition indicative of the occurrence of a thermal runaway event associated with a battery pack 200 is satisfied when at least one of a temperature associated with the battery pack 200 (e.g., an ambient temperature within the battery enclosure 205, a temperature of the external housing 220 of the battery enclosure 205, a temperature of a battery pack 200, and/or a temperature of a battery cell 210) exceeds a threshold, an amount and/or concentration of a gas (e.g., hydrogen, carbon monoxide, carbon dioxide, and/or one or more various other hydrocarbons) within the battery enclosure 205 exceeds a threshold, a voltage associated with the battery pack 200 exceeds a threshold, or a current output by the battery pack 200 exceeds a threshold. In some examples, the VCU 305 determines that a condition indicative of the occurrence of a thermal runaway event associated with a battery pack 200 is satisfied when at least two of a temperature associated with the battery pack 200 (e.g., an ambient temperature within the battery enclosure 205, a temperature of the external housing 220 of the battery enclosure 205, a temperature of a battery pack 200, and/or a temperature of a battery cell 210) exceeds a threshold, an amount and/or concentration of a gas (e.g., hydrogen, carbon monoxide, carbon dioxide, and/or one or more various other hydrocarbons) within the battery enclosure 205 exceeds a threshold, a voltage associated with the battery pack 200 exceeds a threshold, or a current output by the battery pack 200 exceeds a threshold. In some examples, the VCU 305 determines that a condition indicative of the occurrence of a thermal runaway event associated with a battery pack 200 is satisfied when at least three of a temperature associated with the battery pack 200 (e.g., an ambient temperature within the battery enclosure 205, a temperature of the external housing 220 of the battery enclosure 205, a temperature of a battery pack 200, and/or a temperature of a battery cell 210) exceeds a threshold, an amount and/or concentration of a gas (e.g., hydrogen, carbon monoxide, carbon dioxide, and/or one or more various other hydrocarbons) within the battery enclosure 205 exceeds a threshold, a voltage associated with the battery pack 200 exceeds a threshold, or a current output by the battery pack 200 exceeds a threshold.

In response to determining that a condition indicative of the occurrence of a thermal runaway event associated with a battery pack 200 is satisfied, the VCU 305 performs one or more responsive actions to mitigate the damage caused by and/or safety risk attributed to the thermal runaway event associated with the battery pack 200.

In some examples, in response to determining that a condition indicative of the occurrence of a thermal runaway event associated with a battery pack 200 is satisfied, the VCU 305 transmits an alert message to one or more communication devices 380 associated with operators of the electric mining machine 100 and/or people working on a jobsite near the electric mining machine 100. The alert message can, for example, indicate that a thermal runaway event has occurred and instruct people to evacuate the area near the electric mining machine 100. In some examples, in response to determining that a condition indicative of the occurrence of a thermal runaway event associated with a battery pack 200 is satisfied, the VCU 305 activates a display included in the user-interface 325 to display a notification that a thermal runaway event is occurring. In some examples, in response to determining that a condition indicative of the occurrence of a thermal runaway event associated with a battery pack 200 is satisfied, the VCU 305 activates an audible indicator included in the user-interface 325.

In some examples, in response to determining that a condition indicative of the occurrence of a thermal runaway event associated with a battery pack 200 is satisfied, the VCU 305 disconnects components in the electric mining machine 100 from high voltage power supplies included in and/or coupled to the electric mining machine 100. For example, the VCU 305 disconnects the VCU 305 and/or other components of the electric mining machine 100 from the energy storage system 110. As another example, the VCU 305 opens the contactors 355 to disconnect the electric mining machine 100 from the AC power supply 375. Furthermore, in some examples, in response to determining that a condition indicative of the occurrence of a thermal runaway event associated with a battery pack 200 is satisfied, the VCU 305 connects to and is powered by the auxiliary power supply 360.

In some examples, to mitigate damage to the electric mining machine 100 in response to determining that a condition indicative of the occurrence of a thermal runaway event associated with a battery pack 200 is satisfied, the VCU 305 causes cooling water to flow from the water supply 365 into the battery enclosure 205. For example, the VCU 305 activates a pump 340 and/or opens a valve 340 to cause water to flow from the water supply 365 into the battery enclosure 205 via the water inlet 235. As water flows into the battery enclosure 205, the water level within the battery enclosure 205 rises such that the water comes into contact with and surrounds one or more battery packs 200. As described herein, each battery pack 200 includes a housing that surrounds the battery cells 210 included in the battery pack 200. In this regard, the water comes into contact with the respective housings of the battery packs 200. In some examples, the VCU 305 continues to cause water to flow from the water supply 365 into the battery enclosure 205 until the water level within the battery enclosure 205 exceeds a target water level.

In the illustrated examples of FIGS. 2 and 4, the battery enclosure 205 includes a single water inlet 235 disposed at or near the bottom of the battery enclosure 205. However, in some examples, the battery enclosure 205 includes one or more additional water inlets that are disposed at or near the top of the battery enclosure 205. In such examples, during a thermal runaway event associated with a battery pack 200, the VCU 305 causes water to flow into the battery enclosure in a first stream via the water inlet 235 disposed at or near the bottom of the battery enclosure 205 and in a second stream via the additional water inlets disposed at or near the top of the battery enclosure 205. In some examples, the first stream of water that enters the battery enclosure 205 from the water inlet 235 disposed at or near the bottom of the battery enclosure 205 is larger than the second stream of water that enters the battery enclosure 205 from the additional water inlets disposed at or near the top of the battery enclosure 205. In some examples, the second stream of water entering the battery enclosure 205 via the water inlets disposed at or near the top of the battery enclosure 205 is introduced to the battery enclosure 205 as a mist that falls over the battery packs 200.

As shown in FIG. 4, the thermal management system 400 includes one or more water level sensors 415 that are configured to sense the water level within the battery enclosure 205. In operation, the one or more water level sensors 415 sense a water level within the battery enclosure 205 and transmit signals indicative of the water level within the battery enclosure 205 to the VCU 305. In some examples, the VCU 305 can control whether water flows into the battery enclosure 205 based on the sensed water level within the battery enclosure 205. For example, the VCU 305 can turn off a pump 340 and/or close a valve 340 to stop water from flowing into the battery enclosure 205 via the water inlet 235 when the sensed water level within the battery enclosure 205 exceeds a target water level. As another example, the VCU 305 can activate a pump 340 and/or open a valve 340 to cause water to flow into the battery enclosure 205 via the water inlet 235 when the sensed water level within the battery enclosure 205 is less than a target water level. In some examples, the VCU 305 activates a pump 340 and/or opens a valve 340 to drain water from the battery enclosure 205 via the drain 240 when the sensed water level within the battery enclosure 205 exceeds a target water level.

After water flows into and fills the battery enclosure 205 to the target water level threshold during a thermal runaway event associated with a battery pack 200, heat generated and dissipated by the battery pack 200 during the thermal runaway event heats up and evaporates the water. The evaporated water exits the battery enclosure 205 as steam via the one or more vents 230, thereby dissipating thermal energy from the battery enclosure 205 and cooling off the energy storage system 110. In addition, evaporation of water in the battery enclosure causes the water level within the battery enclosure 205 to lower. For example, enough water can be evaporated and exit the battery enclosure 205 via vents 230 as steam during a thermal runaway event such that the water level within the battery enclosure 205 lowers below the target water level. Accordingly, in such an example, as the one or more water level sensors 415 sense and transmits signals indicative of the water level within the battery enclosure 205 to the VCU 305, the VCU 305 determines that the water level within the battery enclosure 205 has dropped below the target water level based on the signals received from the one or more water level sensors 415. In response to determining that the water level within the battery enclosure 205 has dropped below the target water level during a thermal runaway event associated with a battery pack 200, the VCU 305 can activate a pump 340 and/or open a valve 340 to cause more water to flow from the water supply 365 into the battery enclosure 205 via the water inlet 235.

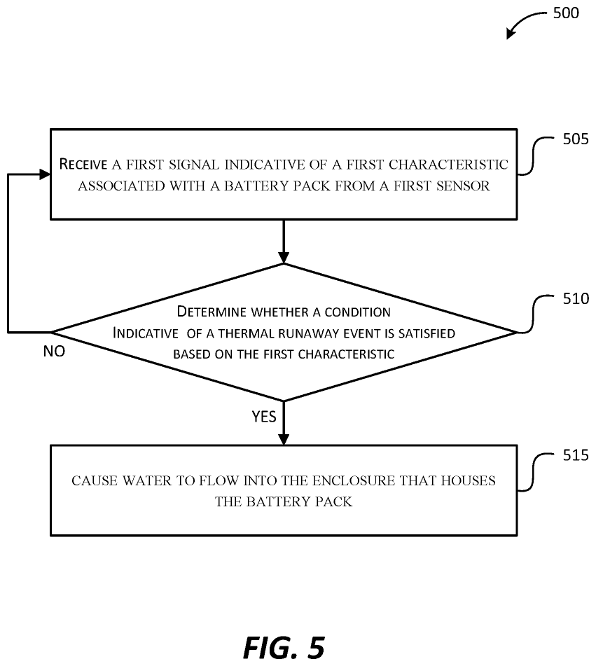

FIG. 5 is a flow diagram of method steps for mitigating thermal runaway in an electric vehicle, such as electric mining machine 100, according to various embodiments. Although the method steps are described in conjunction with the systems of FIGS. 1A-4, persons skilled in the art will understand that any system configured to perform the method steps, in any order, is within the scope of the present disclosure.

As shown, a method 500 begins at step 505, at which a controller receives a first signal indicative of a first characteristic associated with a battery pack from a first sensor. For example, the VCU 305 receives a signal indicative of an amount and/or concentration of a gas (e.g., hydrogen, carbon monoxide, carbon dioxide, and/or one or more various other hydrocarbons) within the battery enclosure 205 from a gas sensor 405. As another example, the VCU 305 receives a signal indicative of a temperature associated with the battery pack 200 (e.g., an ambient temperature within the battery enclosure 205, a temperature of the external housing 220 of the battery enclosure 205, a temperature of a battery pack 200, and/or a temperature of a battery cell 210) from a temperature sensor 410 or a temperature sensor included in and/or coupled to the BMS 215. As another example, the VCU 305 receives a signal indicative of a voltage and/or a current associated with the battery pack 200 from a sensor included in and/or coupled to the BMS 215.

At step 510, the controller determines whether a condition indicative of a thermal runaway event is satisfied based on the first characteristic associated with the battery pack received at step 505. For example, the VCU 305 determines, based on the amount and/or concentration of the gas within the battery enclosure 205, whether a condition indicative of a thermal runaway event is satisfied. In this example, the VCU 305 determines that a condition indicative of a thermal runaway event is satisfied when the amount and/or concentration of the gas exceeds a gas threshold. As another example, the VCU 305 determines, based on the temperature associated with the battery pack 200, whether a condition indicative of a thermal runaway event is satisfied. In this example, the VCU 305 determines that a condition indicative of a thermal runaway event is satisfied when the temperature associated with the battery pack 200 exceeds a temperature threshold. As another example, the VCU 305 determines, based on the voltage and/or the current associated with the battery pack 200, whether a condition indicative of a thermal runaway event is satisfied. In this example, the VCU 305 determines that a condition indicative of a thermal runaway event is satisfied when the voltage associated with the battery pack 200 traverses a voltage threshold and/or the current associated with the battery pack 200 exceeds a current threshold.

If, at step 510, the controller determines that the condition indicative of a thermal runaway event is not satisfied, the method 500 returns to step 505. For example, if the VCU 305 determines that the amount and/or concentration of the gas within the battery enclosure 205 is less than the gas threshold, the method returns to step 505. As another example, if the VCU 305 determines that the temperature associated with the battery pack 200 is less than the temperature threshold, the method returns to step 505. As another example, if the VCU 305 determines that the voltage associated with the battery pack 200 does not traverse the voltage threshold and/or the current associated with the battery pack 200 is less than the current threshold, the method returns to step 505.

If, at step 510, the controller determines that the condition indicative of a thermal runaway event is satisfied, the method 500 proceeds to step 515. For example, if the VCU 305 determines that the amount and/or concentration of the gas within the battery enclosure 205 exceeds the gas threshold, the method proceeds to step 515. As another example, if the VCU 305 determines that the temperature associated with the battery pack 200 exceeds the temperature threshold, the method proceeds to step 515. As another example, if the VCU 305 determines that the voltage associated with the battery pack 200 traverses the voltage threshold and/or the current associated with the battery pack 200 exceeds the current threshold, the method proceeds to step 515.

At step 515, the controller causes water to flow into the enclosure that houses the battery pack through an inlet. For example, the VCU activates a pump 340 and/or opens a valve 340 to cause water to flow into the battery enclosure 205 via the water inlet 235. In some examples, the controller continues to cause water to flow into the enclosure that houses the battery pack while the condition indicative of a thermal runaway event is satisfied and stops causes water to flow into the enclosure that houses the battery pack if the condition indicative of a thermal runaway event is no longer present.

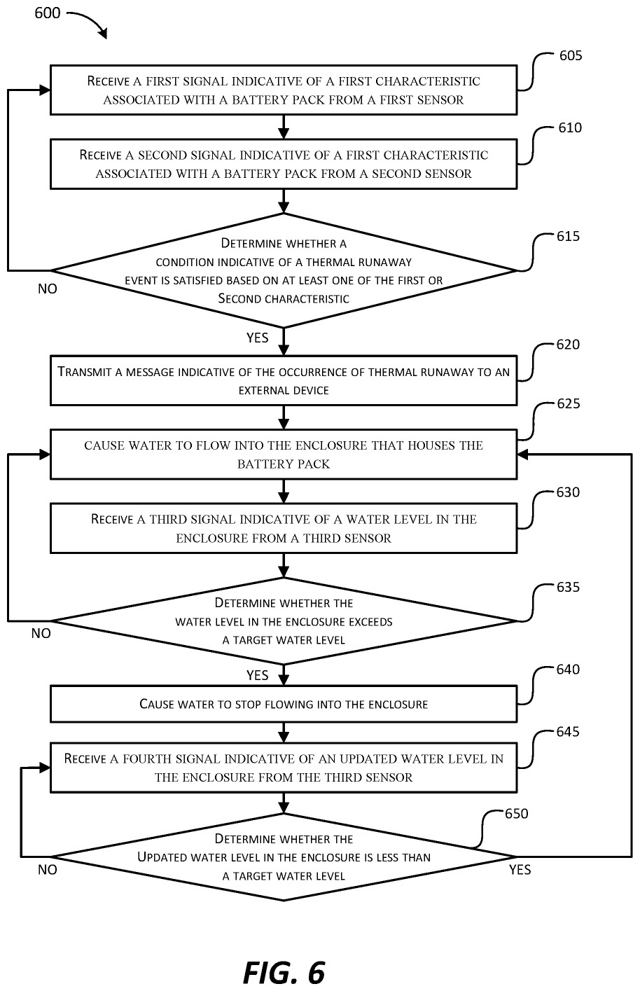

FIG. 6 is a flow diagram of method steps for mitigating thermal runaway in an electric vehicle, such as electric mining machine 100, according to other various embodiments. Although the method steps are described in conjunction with the systems of FIGS. 1A-4, persons skilled in the art will understand that any system configured to perform the method steps, in any order, is within scope of the present disclosure.

As shown, a method 600 begins at step 605, at which a controller receives a first signal indicative of a first characteristic associated with a battery pack from a first sensor. For example, the VCU 305 receives a signal indicative of an amount and/or concentration of a gas (e.g., hydrogen, carbon monoxide, carbon dioxide, and/or one or more various other hydrocarbons) within the battery enclosure 205 from a gas sensor 405.

At step 610, the controller receives a second signal indicative of a second characteristic associated with the battery pack from a second sensor. For example, the VCU 305 receives a signal indicative of a temperature associated with the battery pack 200 (e.g., an ambient temperature within the battery enclosure 205, a temperature of the external housing 220 of the battery enclosure 205, a temperature of a battery pack 200, and/or a temperature of a battery cell 210) from a temperature sensor 410 or a temperature sensor included in and/or coupled to the BMS 215.

At step 615, the controller determines whether a condition indicative of a thermal runaway event is satisfied based on at least one of the first characteristic associated with the battery pack received at step 605 or the second characteristic associated with the battery pack received at step 610. For example, the VCU 305 determines, based on at least one of the amount and/or concentration of the gas within the battery enclosure 205 or the temperature associated with the battery pack 200, whether a condition indicative of a thermal runaway event is satisfied. In this example, the VCU 305 determines that a condition indicative of a thermal runaway event is satisfied when at least one of the amount and/or concentration of the gas exceeds a gas threshold and/or the temperature associated with the battery pack 200 exceeds a temperature threshold.

If, at step 615, the controller determines that the condition indicative of a thermal runaway event is not satisfied, the method 600 returns to step 605. For example, if the VCU 305 determines that the amount and/or concentration of the gas within the battery enclosure 205 is less than the gas threshold and the temperature associated with the battery pack 200 is less than the temperature threshold, the method returns to step 605.

If, at step 615, the controller determines that the condition indicative of a thermal runaway event is satisfied, the method 600 proceeds to step 620. For example, if the VCU 305 determines that at least one of the amount and/or concentration of the gas exceeds the gas threshold and/or the temperature associated with the battery pack 200 exceeds the temperature threshold, the method proceeds to step 620.

At step 620, the controller transmits a message indicative of the occurrence of thermal runaway to an external device. For example, the VCU 305 transmits, via the communication interface included in the I/O system 320, a message that indicates the occurrence of a thermal runaway event to an external communication device 380 associated with operator of the electric mining machine 100.

At step 625, the controller causes water to flow into the enclosure that houses the battery pack through an inlet. For example, the VCU activates a pump 340 and/or opens a valve 340 to cause water to flow into the battery enclosure 205 via the water inlet 235.

At step 630, the controller receives a third signal indicative of a water level in the enclosure that houses the battery pack from a third sensor. For example, the VCU 305 receives a signal indicative of the water level in the battery enclosure 205 from a water level sensor 415.

At step 635, the controller determines whether the water level in the enclosure exceeds a target water level. For example, the VCU 305 determines whether the water level in the battery enclosure 205 exceeds a target water level. If, at step 635, the controller determines that the water level in the enclosure does not exceed the target water level, the method returns to step 630. If, at step 635, the controller determines that the water level in the enclosure does exceed the target water level, the method proceeds to step 640.

At step 640, the controller causes water to stop flowing into the enclosure that houses the battery pack. For example, the VCU 305 shuts of the pump 340 and/or closes the valve 340 to stop water from flowing into the battery enclosure 205.

At step 645, the controller receives a fourth signal indicative of the updated water level in the enclosure that houses the battery pack from the fourth sensor. For example, the VCU 305 receives a signal indicative of the updated water level in the battery enclosure 205 from a water level sensor 415.

At step 650, the controller determines whether the updated water level in the enclosure is less than the target water level. For example, the VCU 305 determines whether the updated water level in the battery enclosure 205 is less than target water level. If, at step 650, the controller determines that the updated water level in the enclosure is not less than the target water level, the method returns to step 645. If, at step 650, the controller determines that the updated water level in the enclosure is less than the target water level, the method returns to step 625.

Although certain aspects have been described with reference to certain examples, variations and modifications exist within the spirit and scope of one or more independent aspects. Various features and aspects are set forth in the following claims.

Any and all combinations of any of the claim elements recited in any of the claims and/or any elements described in this application, in any fashion, fall within the contemplated scope of the present disclosure and protection. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine.

The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A thermal management system comprising:
an enclosure housing a battery pack, wherein the enclosure includes an inlet;
a sensor configured to sense a characteristic associated with the battery pack; and
a controller coupled to the sensor, wherein the controller is configured to:
receive a signal indicative of the characteristic associated with the battery pack from the sensor;
determine, based on the characteristic associated with the battery pack, that a condition indicative of a thermal runaway event is satisfied; and
in response, cause water to flow into the enclosure through the inlet.

2. The system of claim 1, wherein the characteristic associated with the battery pack includes at least one of an amount of a gas within the enclosure, a concentration of a gas within the enclosure, an ambient temperature within the enclosure, a temperature of the battery pack, a voltage of the battery pack, or a current output by the battery pack.

3. The system of claim 1, wherein the controller is further configured to disconnect the battery pack from a component of the thermal management system in response to determining that the condition indicative of the thermal runaway event is satisfied.

4. The system of claim 1, wherein the sensor is a first sensor, the characteristic is a first characteristic associated with the battery pack, and the signal is a first signal, the system further comprising a second sensor configured to sense a water level within the enclosure.

5. The system of claim 4, wherein the controller is further configured to:
receive a second signal indicative of a water level within the enclosure from the second sensor;
determine, based on the second signal, that the water level within the enclosure exceeds a target water level; and
in response, cause water to stop flowing into the enclosure.

6. The system of claim 5, wherein the controller is further configured to:
receive a third signal indicative of an updated water level within the enclosure from the second sensor;
determine, based on the third signal, that the updated water level within the enclosure is less than the target water level; and
in response, cause water to flow into the enclosure through the inlet.

7. The system of claim 1, wherein the controller is further configured to transmit a message that indicates the occurrence of a thermal runaway event to an external device in response to determining that the condition indicative of the thermal runaway event is satisfied.

8. The system of claim 1, further comprising a second sensor configured to sense a second characteristic associated with the battery pack; and
wherein the controller is further configured to receive a second signal indicative of the second characteristic associated with the battery pack from the second sensor.

9. The system of claim 8, wherein the characteristic associated with the battery pack is a concentration of a gas within the enclosure and the second characteristic associated with the battery pack is an ambient temperature within the enclosure.

10. The system of claim 9, wherein to determine that the condition indicative of the thermal runaway event is satisfied, the controller is further configured to:
determine, based on the signal, that the concentration of the gas within the enclosure exceeds a first threshold; or
determine, based on the second signal, that the temperature within the enclosure exceeds a second threshold.

11. A method for mitigating thermal runaway, the method comprising:
receiving, from sensor, a signal indicative of a characteristic associated with a battery pack;
determining, based on the characteristic associated with the battery pack, that a condition indicative of a thermal runaway event is satisfied; and
in response, causing water to flow into an enclosure that houses the battery pack.

12. The method of claim 11, further comprising transmitting a message indicative of the occurrence of a thermal runaway event to an external device in response to determining that the condition indicative of the thermal runaway event is satisfied.

13. The method of claim 11, further comprising:
receiving, from a second sensor, a second signal indicative of a water level within the enclosure;
determining, based on the second signal, that the water level within the enclosure exceeds a target water level; and
in response, causing water to stop flowing into the enclosure.

14. The method of claim 12, further comprising:
receiving, from the second sensor, a third signal indicative of an updated water level within the enclosure;
determining, based on the third signal, that the updated water level within the enclosure is less than the target water level; and
in response, causing water to flow into the enclosure.

15. The method of claim 11, wherein determining that the condition indicative of the thermal runaway event is satisfied includes determining, based on the signal, that an amount of gas within the enclosure exceeds a threshold.

16. The method of claim 11, wherein determining that the condition indicative of the thermal runaway event is satisfied includes determining, based on the signal, that a temperature within the enclosure exceeds a threshold.

17. An electric vehicle comprising:
a plurality of traction devices supporting the electric vehicle for movement;
an enclosure housing a battery pack that provides power to one or more components included in the electric vehicle;
a first sensor configured to sense a first characteristic associated with the battery pack;
a second sensor configured to sense a second characteristic associated with the battery pack; and
a controller coupled to the first sensor, wherein the controller is configured to:
receive a first signal indicative of the first characteristic associated with the battery pack from the first sensor;
receive a second signal indicative of the second characteristic associated with the battery pack from the second sensor;
determine, based on at least one of the first characteristic associated with the battery pack or the second characteristic associated with the battery pack, that a condition indicative of a thermal runaway event is satisfied; and
in response, transmit a message that indicates the occurrence of a thermal runaway event to an external device.

18. The electric vehicle of claim 17, wherein the controller is further configured to cause water to flow into the enclosure in response to determining that the condition indicative of the thermal runaway event is satisfied.

19. The electric vehicle of claim 17, wherein the first characteristic associated with the battery pack is a voltage associated with the battery pack and the second characteristic associated with the battery pack is a current associated with the battery pack.

20. The electric vehicle of claim 17, wherein the electric vehicle is a mining machine including an attachment for drilling holes in a mine surface.
